(19) United States
(12) Patent Application Publication
(10) Pub. No.: US 2026/0126650 A1
(43) Pub. Date: May 7, 2026

(54) ACTUATOR FOR HEAD-UP DISPLAY

(71) Applicant: HYUNDAI MOBIS CO., LTD., Seoul (KR)

(72) Inventor: Byung Ki KIM, Yongin-si (KR)

(73) Assignee: HYUNDAI MOBIS CO., LTD., Seoul (KR)

(21) Appl. No.: 19/324,865

(22) Filed: Sep. 10, 2025

(30) Foreign Application Priority Data
Nov. 1, 2024 (KR) 10-2024-0153433

(51) Int. Cl. G02B 27/01; F16F 15/04; F16F 15/14; F16H 37/12

(52) U.S. Cl. CPC G02B 27/0149; F16F 15/04; F16F 15/1485; F16H 37/126; F16F 2222/08; G02B 2027/0159

(57) ABSTRACT

An actuator for head-up display including a link coupled with one end of an aspherical mirror, a driving force transmission including a lead screw to move the link, a driver to rotate the lead screw in a direction of a rotation axis of a motor according to driving of the motor, a lead screw bracket coupled to the driver and supporting the driver, a vibration damper disposed between the driver and the lead screw bracket to absorb vibration of the motor, and a balance plate disposed adjacent to a lower end portion of the motor to damp the vibration of the motor. The driver includes a rotor shaft that extends along the rotation axis of the motor, and the balance plate is coupled to the rotor shaft.

### CROSS-REFERENCE TO RELATED APPLICATION

This application claims the benefit of and priority to Korean Patent Application No. 10-2024-0153433, filed on Nov. 1, 2024, the entire disclosure of which is hereby incorporated herein by reference in its entirety.

### TECHNICAL FIELD

The present disclosure relates to an actuator for a head-up display, and more specifically, to a vibration damping device that damps vibration of a motor using a balance plate.

### BACKGROUND

The content described in this section simply provides background information for the present disclosure and does not constitute prior art.

A head-up display is a device that displays images including vehicle speed, fuel level, route guidance information, or the like on a windshield, which is a front window of a vehicle. The head-up display is generally configured to display information of display projected from a picture generation unit on a windshield.

The head-up display according to the related art rotates an aspheric mirror using a motor. Here, the aspheric mirror receives rotational power of the motor by making point contact with a power transmission that transmits the rotational power of the motor. When the aspherical mirror makes point contact with a power transmission, external force due to vibration and friction of the motor is concentrated at one point, which may cause wear and geometric transformation of the aspherical mirror.

In the head-up display according to the related art, when the motor is driven based on high RPM, the vibration of the motor cannot be attenuated, and noise is generated accordingly. In addition, backlash occurs between a link and a lead screw that move horizontally based on the rotational power of the motor.

The backlash that occurs between the link and the lead screw reduces the operation and reliability of the head-up display drive module. In other words, errors occur during the power transmission of a head-up display drive module, and vibration and noise occur due to external impacts, or the like.

### SUMMARY

A main object of an actuator for head-up display according to one embodiment is to secure the stability of the entire system by adjusting a rotational balance of a motor using a balance plate.

A main object of the actuator for head-up display according to one embodiment is to damp vibration caused by imbalance of a motor by using the balance plate.

The problems to be solved by the present disclosure are not limited to the problems mentioned above, and other problems not mentioned can be clearly understood by those skilled in the art from the description below.

According to an embodiment of the present disclosure, there is provided an actuator for head-up display comprising a link configured to be coupled with one end of an aspherical mirror, a driving force transmission including a lead screw configured to move the link, a driver configured to rotate the lead screw in a direction of a rotation axis of a motor according to driving of the motor, a lead screw bracket coupled to the driver and supporting the driver, a vibration damper disposed between the driver and the lead screw bracket and configured to absorb vibration of the motor, and a balance plate disposed adjacent to a lower end portion of the motor and configured to damp the vibration of the motor. The driver includes a rotor shaft that extends along the rotation axis of the motor, and the balance plate is coupled to the rotor shaft.

The rotor shaft may extend from the lower end portion of the motor toward the balance plate so that the lower end portion of the motor and the balance plate face each other at a constant interval.

The balance plate may be disposed such that a rotation axis of the balance plate is disposed in the same axial direction as the rotation axis of the motor, and may be coupled with the rotor shaft.

The balance plate may include a first hole or a second hole disposed at a preset position along a circumference of the balance plate.

The first hole may form a plurality of first holes disposed at a constant interval along the circumference of the balance plate.

The balance plate may further include a weight that is configured to be inserted into at least one of the plurality of first holes according to the vibration of the motor to damp the vibration.

In the balance plate, a size and/or arrangement of the second hole may be adjustable according to the vibration of the motor.

The balance plate may be coupled with the rotor shaft so that a rotational axis of the balance plate is disposed at an eccentric position from the rotational axis of the motor.

The weight may include a metal material.

The damper may include: a through hole disposed through both ends of a motor bracket configured to surround the motor; a damper that is fit-coupled into the lead screw bracket to absorb vibration of the motor and includes a damper hole corresponding to the through hole; a shoulder screw that penetrates the through hole, the damper hole, and the lead screw bracket; and a nut coupled to the shoulder screw.

According to the actuator for head-up display according to one embodiment, it is possible to secure stability of the entire system by adjusting the rotational balance of the motor by using the balance plate.

According to the actuator for head-up display according to one embodiment, it is possible to damp vibration caused by imbalance of the motor by using the balance plate.

### BRIEF DESCRIPTION OF THE DRAWINGS

FIG. 1 is a perspective view illustrating an actuator for head-up display according to one embodiment of the present disclosure.

FIG. 2 is an exploded perspective view illustrating the actuator for head-up display according to one embodiment of the present disclosure.

FIG. 3 is a front view illustrating a first embodiment of a balance plate according to one embodiment of the present disclosure.

FIG. 4 is a perspective view illustrating the actuator for head-up display including a weight added to one embodiment of FIG. 3.

FIG. 5 is a front view illustrating a second embodiment of the balance plate according to one embodiment.

FIG. 6 is a front view illustrating a third embodiment of the balance plate according to one embodiment.

### DETAILED DESCRIPTION

Hereinafter, some embodiments of the present disclosure will be described in detail with reference to exemplary drawings. Note that when components in each drawing are denoted by reference numerals, the same components are denoted by the same numerals as much as possible even if they are denoted on different drawings. In addition, in describing the present disclosure, if it is determined that a specific description of a related known configuration or function may obscure the gist of the present disclosure, the detailed description thereof will be omitted.

In describing the components of the embodiments according to the disclosure, reference numerals such as first, second, i), ii), a), and b) may be used. These reference numerals are merely used to distinguish the components from other components, and the nature, sequence, order, and the like of the components are not limited by the reference numerals. In the specification, when a portion is referred to as “comprising” or “including” a component, this means that other components may be further included instead of excluding other components unless explicitly stated to the contrary.

In describing components of the present disclosure, reference terms such as first, second, A, B, (a), and (b) may be used. These terms are only used to distinguish the components from other components, and the nature, sequence, order, or the like of that component is not limited by the terms.

When a component is described as being “connected”, “coupled” or “joined” to another component, it should be understood that the component may be directly connected or joined to the other component, but that another component may be “connected”, “coupled” or “joined” between each component.

The terms “portion”, “module”, and the like described in the specification mean a unit that processes at least one function or operation, and may be implemented by hardware or software, or a combination of hardware and software.

It should be noted that, unless otherwise stated, the description of one embodiment may be applied to other embodiments as well.

The description of the disclosure, disclosed with reference to the accompanying drawings, is intended to describe exemplary embodiments of the disclosure and is not intended to represent the only embodiments in which the disclosure may be practiced.

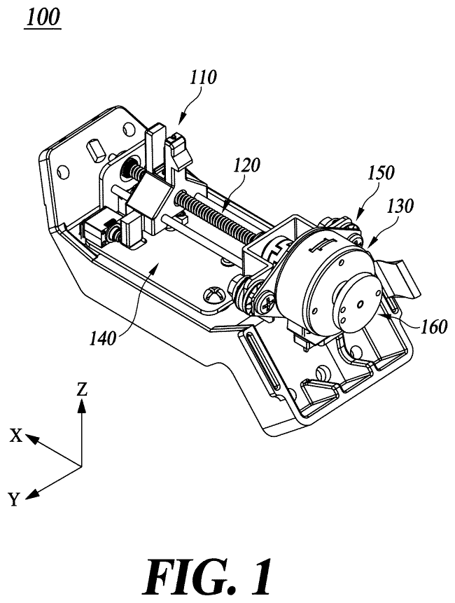

FIG. 1 is a perspective view illustrating an actuator for head-up display according to one embodiment of the present disclosure.

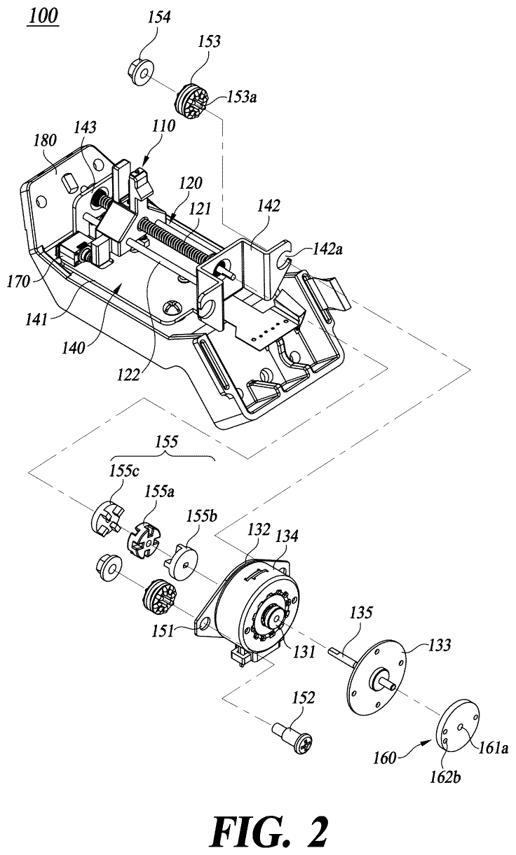

FIG. 2 is an exploded perspective view illustrating the actuator for head-up display according to one embodiment of the present disclosure.

Referring to FIGS. 1 and 2, an actuator for head-up display 100 according to one embodiment of the present disclosure includes some or all of links 110, driving force transmissions 120, a driver 130, a lead screw bracket 140, a vibration damper 150, and a balance plate 160.

The link 110 may be coupled with an aspherical mirror (not illustrated) and the driving force transmission 120. The link 110 may be configured to be coupled with one end of the aspherical mirror. The link 110 may be disposed between the driving force transmission 120 and the aspherical mirror (not illustrated) to connect each component.

A spherical mount (not illustrated) may be formed at both ends of the aspherical mirror so that the aspherical mirror (not illustrated) can rotate. The link 110 may be linked with the driving force transmission 120 to rotate the aspherical mirror along an axis direction in which the spherical mount (not illustrated) rotates.

The driving force transmission 120 may include some or all of a lead screw 121 and a guide shaft 122. The driving force transmission 120 may move the other end of the link 110 in an arc.

The lead screw 121 may be extended and rotated to the rotating shaft of a motor 131, and may be formed as an integral part with the driving force transmission 120 or may be formed as a detachable structure that can be assembled to/separated from the driving force transmission 120. The lead screw 121 may move the link 110.

The guide shaft 122 may be formed parallel to the lead screw 121 and spaced apart from the lead screw 121 between a lead screw mount 143 and a damper mount 142. The guide shaft 122 may be coupled to penetrate a part of the link 110.

When the link 110 moves along the lead screw 121, the guide shaft 122 may guide the movement section so that the link 110 moves without rotating.

The driver 130 may include some or all of the motor 131, a motor bracket 132, a motor mount 133, a body 134, and a rotor shaft 135.

The motor 131 may be a DC motor, an AC motor, an induction motor, a synchronous motor, a step motor, a servo motor, a brushless motor, a linear motor, a permanent magnet synchronous motor (PMSM), or the like.

The motor bracket 132 may be disposed in contact with one surface of the upper end of the motor 131. The upper end of the motor 131 refers to an area in contact with the shaft of the motor 131. The motor bracket 132 may be formed to cover the entire upper end of the motor 131.

The motor bracket 132 may be coupled to the damper mount 142 using a shoulder screw 152. Both ends of the motor bracket 132 may be extended along a direction perpendicular to the axial direction of the motor 131 so as to be coupled with the damper mount 142.

The motor mount 133 may be disposed to be in contact with one surface of a lower end of the motor 131. The motor mount 133 may be formed to cover the entire lower end of the motor 131. The motor mount 133 may be manufactured using a thin metal plate.

The body 134 may be formed between the motor bracket 132 and the motor mount 133. The body 134 may be configured to cover the entire side surface of the motor 131. The body 134 may be formed to be connected to the motor bracket 132. However, the shape of the body 134 is not limited thereto.

The rotor shaft 135 may be formed to extend along the rotation axis of the motor 131. Here, the rotor shaft 135 refers to a central shaft that is coupled with a rotor, which is a component that performs rotational motion in the motor 131, and supports and transmits the rotational motion.

The rotor shaft 135 may be formed to extend from the lower end portion of the motor 131 toward the balance plate 160 so that the lower end portion of the motor 131 and the balance plate 160 face each other at a constant interval. The length extended from the lower end portion of the motor 131 may be adjusted depending on the vibration level of the motor 131.

The lead screw bracket 140 may include some or all of a housing mount 141, the damper mount 142, and the lead screw mount 143. The lead screw bracket 140 may be disposed on the upper end of the motor 131. The lead screw bracket 140 may be coupled to the driver 130 to support the driver 130.

The housing mount 141 may be disposed to be in contact with one surface of a housing 180. The housing 180 may fix the actuator for head-up display 100 to the inside of the head-up display. The housing 180 may include a plurality of bosses (not illustrated) and a plurality of holes (not illustrated) for fixing the position of the housing mount 141.

The plurality of bosses (not illustrated) may determine the position at which the housing mount 141 is coupled to the housing 180. A housing hole (not illustrated) may be formed on one surface of the housing mount 141 so that a tapping screw 181 can pass through the housing mount 141. The tapping screw 181 may pass through the housing hole (not illustrated) and be fastened to the plurality of holes (not illustrated) formed on one surface of the housing 180.

A flexible cable 182 may be disposed between the housing 180 and the bracket of the motor 131. The flexible cable 182 means a conductive wire connected to the motor 131. The flexible cable 182 may be installed so as to be exposed in all directions on the left and right sides based on the housing 180.

A switch 170 may be disposed in one area of the housing mount 141. The switch 170 may detect a driving limit of the aspherical mirror.

The damper mount 142 may be disposed adjacent to the motor bracket 132. The damper mount 142 may be formed by being bent vertically to the housing mount 141. An open hole 142a may be formed on one surface of the damper mount 142 so that a damper 153 can be fit-coupled to the one surface.

The lead screw 121 may be coupled by penetrating one surface of the lead screw mount 143. The lead screw mount 143 may be formed by being bent vertically to the housing mount 141.

The vibration damper 150 may include some or all of a through hole 151, the shoulder screw 152, the damper 153, a nut 154, and a flexible coupling.

The through hole 151 may be formed by penetrating one area of both ends of the motor bracket 132. The shoulder screw 152 may penetrate the through hole 151.

The damper 153 may be fit-coupled to the lead screw bracket 140 to absorb vibration of the motor 131. Specifically, the damper 153 may be fit-coupled to the damper mount 142. The damper 153 can reduce noise generated within the actuator for head-up display 100 by attenuating vibration of the motor 131 passing through the motor bracket 132.

The damper 153 may be placed between the motor bracket 132 and the damper mount 142. The damper 153 may include a damper hole 153a formed to correspond to the through hole 151.

The damper hole 153a may be formed to penetrate one side of the damper 153 so that the shoulder screw 152 can penetrate therethrough. The nut 154 may be coupled to the shoulder screw 152 that penetrates the through hole 151, the damper hole 153a, and the open hole 142a.

A flexible coupling 155 may compensate for the eccentricity between the rotation axis of the motor 131 and the rotation axis of the lead screw 121. The flexible coupling 155 may be coupled with a first hub 155b and a second hub 155c on both sides centered on a spacer 155a.

The rotating shaft of the motor 131 may be fit-coupled to the first hub 155b coupled to one side of the flexible coupling 155. The lead screw 121 may be fit-coupled to the second hub 155c coupled to the other side of the flexible coupling 155.

Even when the rotation axis of the motor 131 and the rotation axis of the lead screw 121 do not coincide, the eccentricity between the axes can be compensated for using the spacer 155a. The flexible coupling 155 according to one embodiment of the present disclosure may be, for example, an Oldham coupling. Here, the Oldham coupling is used as a coupling for compensating for eccentricity between shafts coupled on both sides. However, the type of the flexible coupling 155 is not limited thereto.

The balance plate 160 may be disposed adjacent to the lower end portion of the motor 131. The balance plate 160 may be coupled with the rotor shaft 135 to attenuate vibration of the motor 131.

A rotating shaft hole 161a into which the rotor shaft 135 may be inserted may be formed on one surface of the balance plate 160. The rotating shaft hole 161a may be disposed in the same axial direction as the rotational axis of the motor 131.

The balance plate 160 may be axially coupled with the rotor shaft 135 to support rotational motion. The rotation axis of the balance plate 160 may be formed in the same axial direction as the rotation axis of the motor 131.

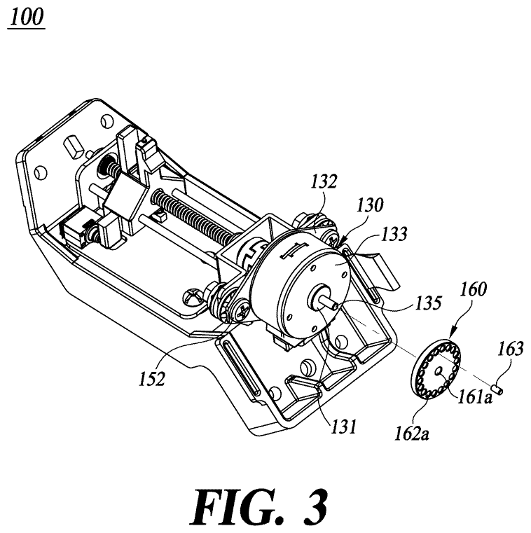

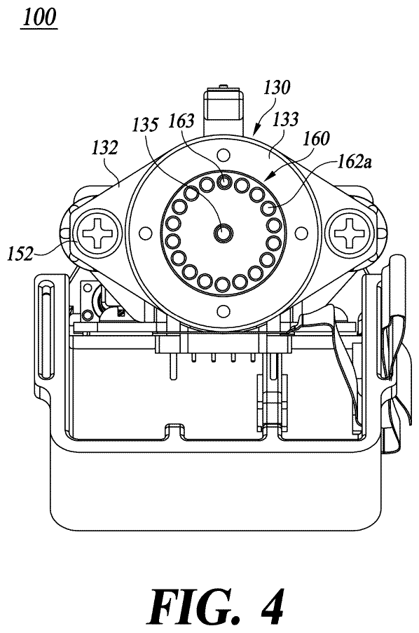

FIG. 3 is a front view illustrating a first embodiment of the balance plate according to one embodiment of the present disclosure. FIG. 4 is a perspective view illustrating an actuator for head-up display including a weight added to the embodiment of FIG. 3. Here, descriptions overlapping with the actuator for head-up display according to the embodiments of FIGS. 1 and 2 are omitted.

Referring to FIGS. 3 and 4, the balance plate 160 may include a first hole 162a and a weight 163.

The first hole 162a may be formed at a preset position along the circumference. Specifically, a plurality of first holes 162a may be formed at regular intervals along the circumference of the balance plate 160.

The size of the first hole 162a may be adjusted according to the vibration of the motor 131. In addition, the spacing between the first holes 162a may be adjusted according to the vibration of the motor 131. That is, in order to control the vibration generated from the motor 131, the number, size, and position of the first holes 162a formed along the circumference on one surface of the balance plate 160 may be adjusted to control the rotational balance of the rotor shaft 135 and damp the vibration.

The weight 163 may be inserted into at least one of the plurality of first holes 162a according to the vibration of the motor 131 to damp the vibration. For example, when the vibration intensity of the motor 131 is low, a small number of weights 163 may be inserted into a certain position to provide a minimum weight change and damp the vibration. When the vibration intensity of the motor 131 is high, multiple weights 163 may be inserted into the plurality of first holes 162a to balance the vibration and damp the vibration.

The weight 163 may be made of metal. Specifically, the weight 163 may be made of a durable material such as steel or an alloy, so that the weight maintains stability even during repeated rotation and vibration, and maximizes vibration damping efficiency.

In addition, the number or position of the weight 163 may be easily changed, so that the user can quickly and efficiently adjust the number or position according to the vibration state of the motor 131.

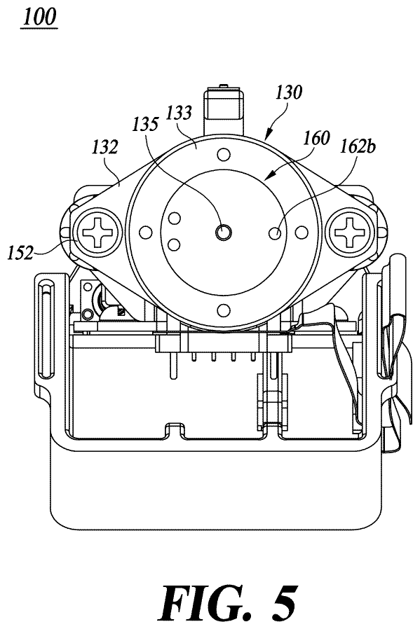

FIG. 5 is a front view illustrating a second embodiment of the balance plate according to one embodiment. Here, descriptions overlapping with the actuator for head-up display according to the embodiments of FIGS. 1 and 2 are omitted.

Referring to FIG. 5, the balance plate 160 may include a second hole 162b formed at a preset position along the circumference of the balance plate 160. Here, the preset position means a position that can most effectively damp vibration according to the vibration of the motor 131, and the preset position may be adjusted according to the direction and intensity of the vibration.

The size of the second hole 162b may be adjusted according to the vibration of the motor 131. In addition, the arrangement of the second holes 162b may be adjusted according to the vibration of the motor 131. For example, when the vibration intensity of the motor 131 is low, the arrangement of the second holes 162b may be uniformly disposed so that the second holes 162b are disposed one by one at equal intervals on the circumference.

Meanwhile, when the vibration intensity of the motor 131 is high, the number of second holes 162b can be increased centered on the direction in which the vibration occurs, so that two holes can be disposed in a specific direction and one hole can be disposed in another direction. This is an explanation of an exemplary configuration, and is not necessarily limited thereto.

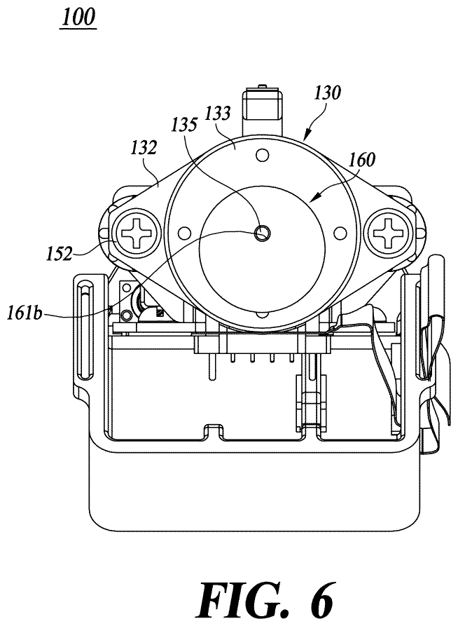

FIG. 6 is a front view illustrating a third embodiment of the balance plate according to one embodiment. Here, the descriptions overlapping with the actuator for head-up display according to the embodiments of FIGS. 1 and 2 are omitted.

Referring to FIG. 6, the rotation axis of the balance plate 160 may be formed at an eccentric position from the rotation axis of the motor 131.

An eccentric shaft hole 161b into which the rotor shaft 135 may be inserted may be formed on one surface of the balance plate 160. The balance plate 160 may be axially coupled with the rotor shaft 135 to support the rotational motion.

The eccentric rotation shaft may correct imbalance that occurs when the motor 131 rotates and attenuate vibration. The eccentric position may be adjusted according to the vibration pattern and intensity of the motor 131, and may effectively suppress vibration that occurs in a specific direction of the motor 131. For example, when vibration of the motor 131 occurs intensively in a specific direction, the rotation axis of the balance plate 160 may be eccentric in the specific direction to offset vibration and maintain stable rotational motion.

The eccentric rotation shaft can contribute to the miniaturization and weight reduction of the actuator for head-up display 100 while increasing the vibration damping efficiency. This is an exemplary configuration description, and the disclosure is not limited thereto.

The above description is merely illustrative of the technical idea of the present embodiment, and various modifications and variations will be possible to those skilled in the art without departing from the essential characteristics of the present embodiment. Therefore, the present embodiments are not intended to limit but to explain the technical idea of the present embodiment, and the scope of the technical idea of this embodiment is not limited by this embodiment. The protection scope of the present embodiment should be interpreted by the following claims, and all technical ideas falling within the scope equivalent thereto should be interpreted as being included in the scope of rights of the present embodiment.

What is claimed is:

1. An actuator for head-up display comprising:
a link configured to be coupled with one end of an aspherical mirror;
a driving force transmission including a lead screw configured to move the link;
a driver configured to rotate the lead screw in a direction of a rotation axis of a motor according to driving of the motor;
a lead screw bracket coupled to the driver and supporting the driver;
a vibration damper disposed between the driver and the lead screw bracket and configured to absorb vibration of the motor; and
a balance plate disposed adjacent to a lower end portion of the motor and configured to damp the vibration of the motor,
wherein the driver includes a rotor shaft that extends along the rotation axis of the motor, and
the balance plate is coupled to the rotor shaft.

2. The actuator for head-up display of claim 1, wherein the rotor shaft extends from the lower end portion of the motor toward the balance plate so that the lower end portion of the motor and the balance plate face each other at a constant interval.

3. The actuator for head-up display of claim 2, wherein the balance plate is disposed such that a rotation axis of the balance plate is disposed in the same axial direction as the rotation axis of the motor, and is coupled with the rotor shaft.

4. The actuator for head-up display of claim 3, wherein the balance plate includes a first hole or a second hole disposed at a preset position along a circumference of the balance plate.

5. The actuator for head-up display of claim 4, wherein the first hole forms a plurality of first holes disposed at a constant interval along the circumference of the balance plate.

6. The actuator for head-up display of claim 5, wherein the balance plate further includes a weight that is configured to be inserted into at least one of the plurality of first holes according to the vibration of the motor to damp the vibration.

7. The actuator for head-up display of claim 4, wherein in the balance plate, a size and/or arrangement of the second hole is adjustable according to the vibration of the motor.

8. The actuator for head-up display of claim 3, wherein the balance plate is coupled with the rotor shaft so that a rotational axis of the balance plate is disposed at an eccentric position from the rotational axis of the motor.

9. The actuator for head-up display of claim 6, wherein the weight comprises a metal material.

10. The actuator for head-up display of claim 1, wherein the vibration damper includes:
a through hole disposed through both ends of a motor bracket configured to surround the motor;
a damper that is fit-coupled into the lead screw bracket to absorb vibration of the motor and includes a damper hole corresponding to the through hole;
a shoulder screw that penetrates the through hole, the damper hole, and the lead screw bracket; and
a nut coupled to the shoulder screw.
